(19) United States
(12) Patent Application Publication
(10) Pub. No.: US 2009/0269029 A1
(43) Pub. Date: Oct. 29, 2009

(54) RECORDING/REPRODUCING DEVICE

(76) Inventor: Kenji Ishikawa, Osaka (JP)

Correspondence Address: MCDERMOTT WILL & EMERY LLP, 600 13TH STREET, NW, WASHINGTON, DC, 20005-3096, US

(21) Appl. No.: 12/067,114

(22) PCT Filed: Jul. 10, 2006
(86) PCT No.: PCT/JP2006/313699

§ 371 Date: Mar. 17, 2008

(30) Foreign Application Priority Data
Oct. 21, 2005 (JP) 2005-306610

(51) Int. Cl. H04N 5/91; H04N 7/26

(52) U.S. Cl. 386/95; 386/109; 715/722; 382/232; 386/E09.001

(57) ABSTRACT

There is provided a recording/reproducing device capable of more efficiently and reliably reproducing a scene desired by a user by adding the individual functions of receiving previously registered information from the user, detecting a match between the previously registered information and literal information, detecting a match between the previously registered information and a sound word, obtaining a feedback from the user, and the like.

### TECHNICAL FIELD

The present invention relates to a recording/reproducing device which detects a highlight scene in image/sound signals.

### BACKGROUND ART

In recent years, a device for recording an image and a sound, such as a video disk recorder with a large capacity HDD, has been widely prevailing on the market. Such a device has various additional functions. For example, a scene reproducing function is known which allows a user to efficiently retrieve and reproduce a desired scene during the reproduction of a recorded program.

Patent Document 1 discloses a method which marks and concurrently records a highlight scene based on predetermined conditions, while detecting the luminance amplitude of an image signal as well as the input amplitude of a sound signal.

### Patent Document 1: Japanese Laid-Open Patent Publication No. 2004-120553

### DISCLOSURE OF THE INVENTION

### Problem to be Solved by the Invention

However, even when the luminance amplitude of the image signal and the input amplitude of the sound signal are used to set conditions for marking the highlight scene and the marking conditions are changed depending on the genre of the image, only the amplitude information of an inputted image and an inputted sound is insufficient in most cases to allow complete coverage of the features of the input image and sound. As a result, there is the problem that a scene desired by the user cannot be efficiently reproduced.

The present invention has been achieved in view of the foregoing and an object of the present invention is to allow efficient and reliable reproduction of a scene desired by a user.

### Means for Solving the Problems

Specifically, a recording/reproducing device according to the present invention includes: an image encoding unit for performing an encoding process with respect to an input image signal and outputting a compressed image data, while outputting an image-related data showing the frame information, luminance data, hue data, and movement vector information of the input image signal; a sound encoding unit for performing an encoding process with respect to an input sound signal and outputting a compressed sound data, while outputting a sound-related data showing the frame information, amplitude data, and spectrum information of the input sound signal; an image feature quantity extraction unit for receiving the image-related data, extracting respective quantities of features of the input image signal based on the image-related data, and outputting a plurality of image feature quantity data; a sound feature quantity extraction unit for receiving the sound-related data, extracting respective quantities of features of the input sound signal based on the sound-related data, and outputting a plurality of sound feature quantity data; a user input unit for receiving input information based on an operation by a user; a genre setting unit for receiving set program information set in the user input unit and outputting program genre information showing a genre corresponding to the set program information; a highlight scene determination unit for receiving the plurality of image feature quantity data and the plurality of sound feature quantity data, weighting both of the feature quantity data in accordance with the program genre information, comparing results of the weighting with reference values for determination of a highlight scene, and outputting a scene determination signal indicating the highlight scene based on results of the comparison; a multiplexing unit for multiplexing the compressed image data and the compressed sound data in accordance with an encoding format and outputting a multiplexed stream data; an accumulation unit for receiving the multiplexed stream data and the scene determination signal, writing both of the data in a recording medium, and reading the recorded multiplexed stream data only during a period in which the scene determination signal is valid when a highlight scene reproduction mode has been set or reading the recorded multiplexed stream data over an entire period when the highlight scene reproduction mode has not been set; a demultiplexing unit for receiving the read stream, demultiplexing the read stream into a demultiplexed image stream and a demultiplexed sound stream, and outputting the demultiplexed image stream and the demultiplexed sound stream; an image decoding unit for receiving the demultiplexed image stream, decompressing the compressed image data, and outputting the decompressed image data as a demodulated image signal; and a sound decoding unit for receiving the demultiplexed sound stream, decompressing the compressed sound data, and outputting the decompressed sound data as a demodulated sound signal, wherein the highlight scene determination unit is constructed to compare the plurality of image feature quantity data and the plurality of sound feature quantity data with results of taking statistics of respective distributions of individual feature quantities of the image and the sound on a per program-genre basis and weight the plurality of image feature quantity data and the plurality of sound feature quantity data based on results of the comparison.

### EFFECT OF THE INVENTION

Thus, in accordance with the present invention, marking conditions for detecting a highlight scene are set based on the plurality of feature quantity data extracted from the image-related information (such as, e.g., the frame information, luminance data, hue data, and movement vector information of the input image signal) and the sound-related information (such as the frame information, amplitude data, and spectrum information of the input sound signal). As a result, it becomes possible to more efficiently reproduce a scene desired by a user compared with the case where approximately one pair of marking conditions are provided (e.g., the luminance amplitude of an image and the magnitude of the amplitude of a sound).

Moreover, by adding the individual functions of receiving previously registered information from the user, detecting a match between the previously registered information and literal information, detecting a match between the previously registered information and a sound word, obtaining a feedback from the user with respect to the result of reproduction, and automatically weighting the feature quantity data based on the viewing history of the user, a recording/reproducing device capable of more efficiently and reliably reproducing a scene desired by the user can be provided.

Further, because there are characteristic situations (a scene change and a mute period) before and after a CM detection period in both image and sound reproduction, CM detection can be performed more stably and reliably by reflecting the result from the highlight scene determination unit on determination parameters for a CM detecting function.

### BRIEF DESCRIPTION OF THE DRAWINGS

FIG. 1 is a block diagram showing a structure of a recording/reproducing apparatus according to Embodiment 1 of the present invention;

FIG. 2 is a block diagram showing a detailed structure of a highlight scene determination unit in Embodiment 1;

FIG. 3 is a view showing the timing relation between a scene determination signal and each of an input image signal and an input sound signal in Embodiment 1;

FIG. 4 is a block diagram showing a structure of a recording/reproducing device according to Embodiment 2 of the present invention;

FIG. 5 is a block diagram showing a detailed structure of the highlight scene determination unit in Embodiment 2;

FIG. 6 is a block diagram showing a structure of a recording/reproducing device according to Embodiment 3 of the present invention;

FIG. 7 is a block diagram showing a detailed structure of the highlight scene determination unit in Embodiment 3;

FIG. 8 is a block diagram showing a structure of a recording/reproducing device according to Embodiment 4 of the present invention;

FIG. 9 is a block diagram showing a detailed structure of the highlight scene determination unit in Embodiment 4;

FIG. 10 is a block diagram showing a structure of a recording/reproducing device according to Embodiment 5 of the present invention;

FIG. 11 is a block diagram showing a detailed structure of the highlight scene determination unit in Embodiment 5;

FIG. 12 is a block diagram showing a structure of a recording/reproducing device according to Embodiment 6 of the present invention;

FIG. 13 is a block diagram showing a detailed structure of the highlight scene determination unit in Embodiment 6;

FIG. 14 is a block diagram showing a detailed structure of the highlight scene determination unit in Embodiment 7 of the present invention; and

FIG. 15 is a block diagram showing a structure of a recording/reproducing device according to Embodiment 8 of the present invention.

### DESCRIPTION OF NUMERALS

3 Image Feature Quantity Extraction Unit
4 Sound Feature Quantity Extraction Unit
5 Highlight Scene Determination Unit
20 User Input Unit
21 Genre Setting Unit
50 Feature Quantity Weighting Circuit
51 Program Genre Factor Table
52 Comparison Unit
53 Program Genre Conversion Table
54 Set Information Factor Table
55 Literal Match Detection Factor Table
56 Sound Match Detection Table
57 Feedback Unit
58 Statistics Unit

### BEST MODE FOR CARRYING OUT THE INVENTION

Referring to the drawings, the embodiments of the present invention will be described hereinbelow in detail. The description of the preferred embodiment given below are essentially only illustrative and are by no means intended to limit the present invention, the application thereof, or the use thereof.

### Embodiment 1

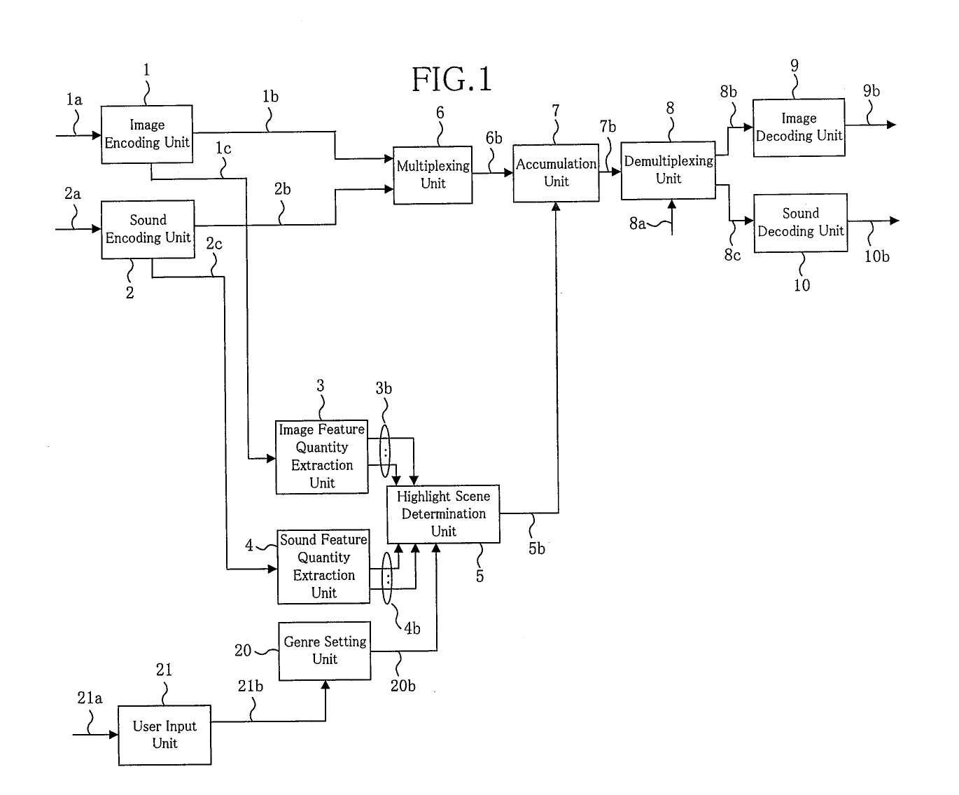

FIG. 1 is a block diagram showing a structure of a recording/reproducing device according to Embodiment 1 of the present invention. In FIG. 1, 1 denotes an image encoding unit for performing an encoding process with respect to an input image signal 1a. From the image encoding unit 1, a compressed image data 1b resulting from compression in the image encoding unit 1 is outputted to a multiplexing unit 6, while an image-related data 1c including the frame information, luminance data, hue data, and movement vector information of the input image signal 1a is outputted to an image feature quantity extraction unit 3.

The image feature quantity extraction unit 3 mentioned above generates image feature quantity data 3b based on the image-related data 1c. For example, by averaging individual data in one image frame, the plurality of image feature quantity data 3b are outputted to a highlight scene determination unit 5.

2 denotes a sound encoding unit for performing an encoding process with respect to an input sound signal 2a. From the sound encoding unit 2, a compressed sound data 2b resulting from compression in the sound encoding unit 2 is outputted to the multiplexing unit 6, while a sound-related data 2c including the frame information, amplitude data, and spectrum information of the input sound signal 2a is outputted to a sound feature quantity extraction unit 4.

The sound feature quantity extraction unit 4 mentioned above generates sound feature quantity data 4b based on the sound-related data 2c. For example, by averaging individual data in one sound frame, the plurality of sound feature quantity data 4b are outputted to the highlight scene determination unit 5.

The multiplexing unit 6 mentioned above multiplexes the inputted compressed image data 1b and the compressed sound data 2b in accordance with an encoding format. From the multiplexing unit 6, a multiplexed stream data 6b resulting from the multiplexing is outputted to an accumulation unit 7.

21 denotes a user input unit for receiving an input 21a from a user. Set program information 21b based on the input 21a is outputted to a genre setting unit 20.

In the genre setting unit 20 mentioned above, program genre information 20b (such as, e.g., news, movies, music programs, or sports) showing a genre corresponding to the inputted set program information 21b is set and outputted to the highlight scene determination unit 5.

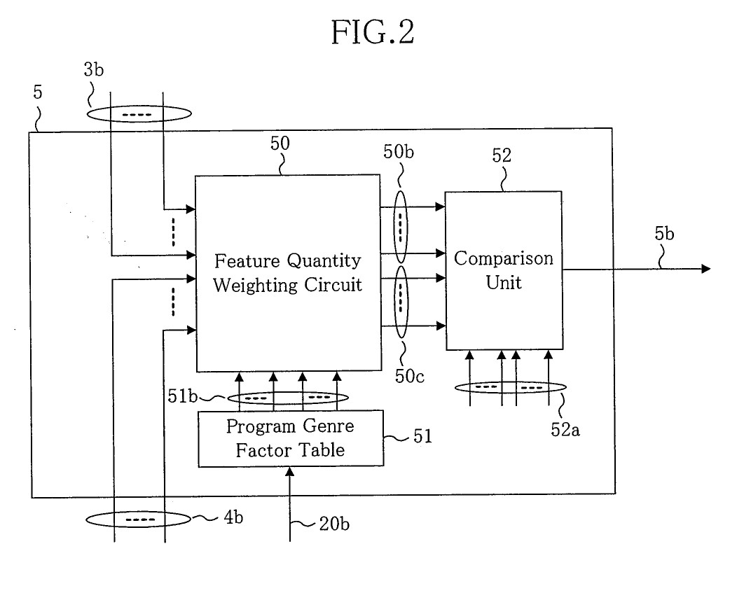

FIG. 2 is a block diagram showing a detailed structure of the highlight scene determination unit 5 in Embodiment 1. In FIG. 2, 50 denotes a feature quantity weighting circuit. To the feature quantity weighting circuit 50, the plurality of image feature quantity data 3b outputted from the image feature quantity extraction unit 3 and the plurality of sound feature quantity data 4b outputted from the sound feature quantity extraction unit 4 are inputted.

51 denotes a program genre factor table. To the program genre factor table 51, the program genre information 20b outputted from the genre setting unit 20 is inputted. From the program genre factor table 51, feature quantity genre factors 51b in accordance with respective feature quantity factors in the individual program genres, which are determined based on the program genre information 20b, are outputted to the feature quantity weighting circuit 50.

The feature quantity weighting circuit 50 mentioned above performs respective multiplications between the plurality of image feature quantity data 3b and the feature quantity genre factors 51b and between the plurality of sound feature quantity data 4b and the feature quantity genre factors 51b. From the feature quantity weighting circuit 50, weighted image data 50b and weighted sound data 50c as the results of the multiplications are outputted to a comparison unit 52.

Thus, the extracted image feature quantity data 3b and the extracted sound feature quantity data 4b are not reflected directly on a system, but there are peculiar parameters intensified on a per program-genre basis (the distribution of feature quantities greatly differs from one genre to another). As a result, by multiplying the image feature quantity data 3b and the sound feature quantity data 4b by the feature quantity genre factors 51b, it is possible to intensify the parameters which are peculiar to the individual genres, while weakening parameters which are not. This allows reliable scene determination.

The comparison unit 52 mentioned above compares the inputted weighted image data 50b and the inputted weight sound data 50c with reference values 52a for the determination of a highlight scene. As a result of the comparison, when the reference values 52a are exceeded, a scene determination signal 5b indicating that the current input signal shows a highlight scene is outputted to the accumulation unit 7.

The accumulation unit 7 mentioned above receives the multiplexed stream data 6b outputted from the multiplexing unit 6 as well as the scene determination signal 5b outputted from the highlight scene determination unit 5, writes both of the data in a recording medium, reads the multiplexed stream data 6b as necessary, and outputs the read multiplexed stream data 6b as a read stream 7b to a demultiplexing unit 8.

Specifically, when a reproduction mode signal 8a inputted to the demultiplexing unit 8 is active in reading the recorded multiplexed stream data 6b, the multiplexed stream data 6b is read and outputted as the read stream 7b only during a period in which the scene determination signal 5b is valid (the period during which the highlight scene is determined).

On the other hand, when highlight scene reproduction is not performed, the multiplexed stream data 6b is read and outputted as the read stream 7b over an entire period.

The demultiplexing unit 8 mentioned above demultiplexes the inputted read stream 7b into a demultiplexed image stream 8b and a demultiplexed sound stream 8c. The demultiplexed image stream 8b is outputted to an image decoding unit 9 and the demultiplexed sound stream 8c is outputted to a sound decoding unit 10.

The image decoding unit 9 mentioned above performs a decompression process with respect to the demultiplexed image stream 8b so that data resulting from the decompression process is reproduced from a demodulated image signal 9b.

The sound decoding unit 10 mentioned above performs a decompression process with respect to the demultiplexed sound stream 8c so that data resulting from the decompression process is reproduced as a demodulated sound signal 10b.

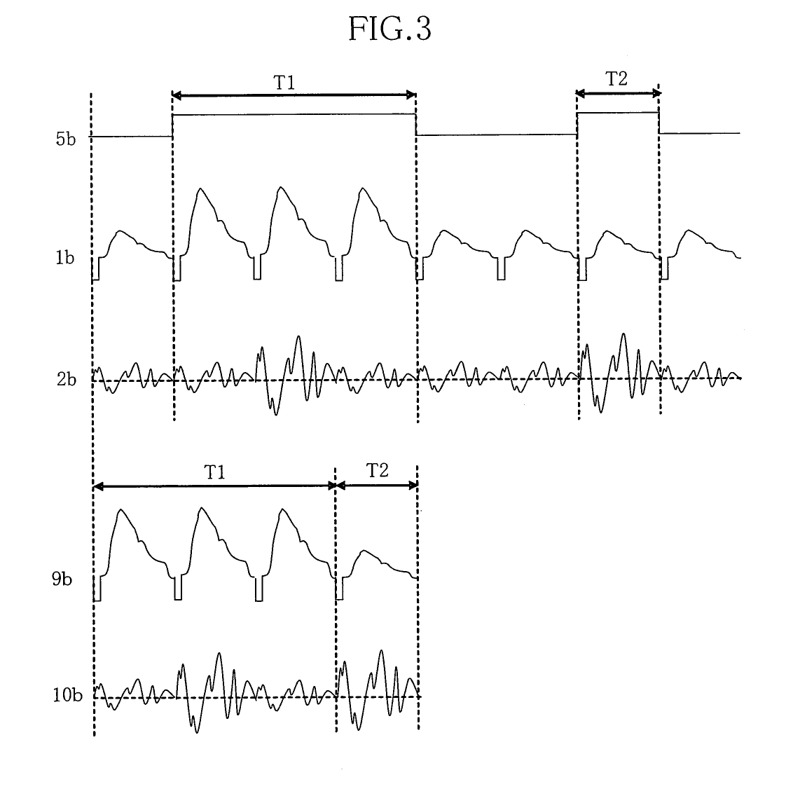

FIG. 3 is a view showing the timing relation between the scene determination signal 5b in the highlight scene determination unit 5 and each of the input image signal 1a and the input sound signal 2a.

As shown in FIG. 3, the scene determination signal 5b becomes active when there are remarkable changes in the plurality of image feature quantity data 3b and in the plurality of sound feature quantity data 4b and when the reference values determined for the individual program genres are exceeded.

Although Embodiment 1 has determined that the scene determination signal 5b is active when the there are remarkable changes in image amplitude and sound amplitude, it is also possible to determine that the scene determination signal 5b is active based on the magnitude of the quantity of the movement vector of an image, the extent of the spectrum of a sound, or the like.

When the reproduction mode signal 8a inputted to the demultiplexing unit 8 mentioned above is active (in a highlight scene reproduction mode), only data during the period in which the scene determination signal 5b is active is read from the recording medium in the accumulation unit 7, and a highlight scene is reproduced from the demodulated image signal 9b and the demodulated sound signal 10b in the image decoding unit 9 and in the sound decoding unit 10.

Thus, in the recording/reproducing device according to Embodiment 1, the marking conditions for the highlight scene are set based on the plurality of image and sound feature quantity data. As a result, a scene desired by the user can be reproduced more efficiently than in the case where approximately one pair of marking conditions (e.g., the luminance amplitude of an image and the magnitude of the amplitude of a sound) are provided.

### Embodiment 2

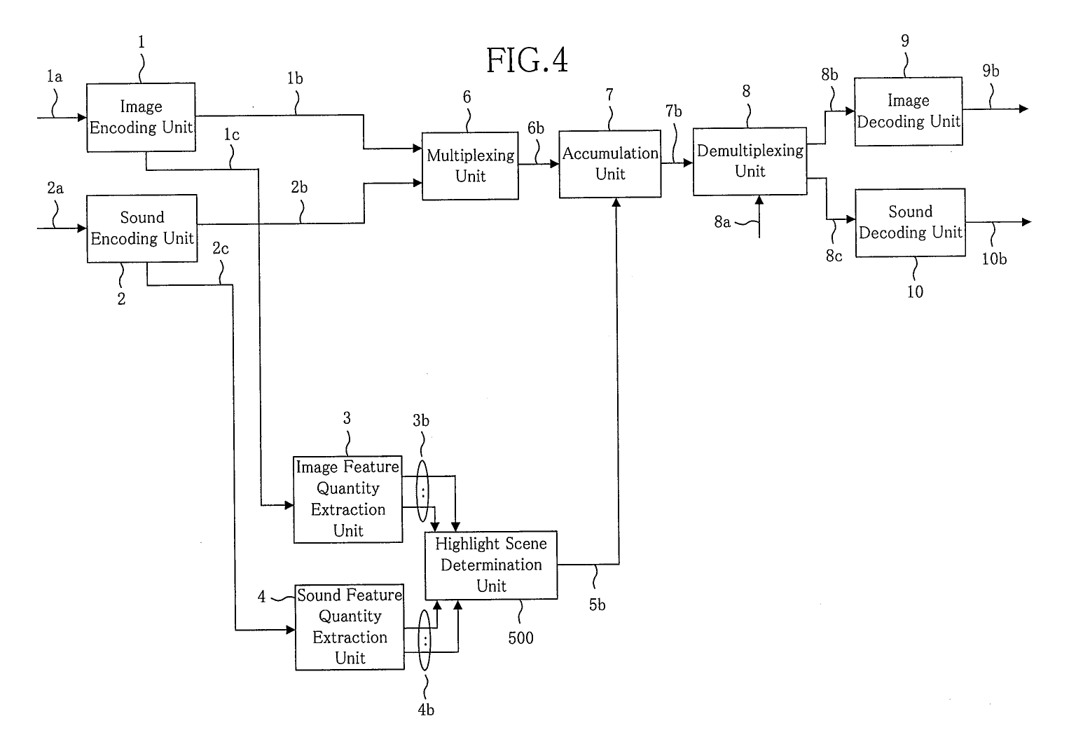

FIG. 4 is a block diagram showing a structure of a recording/reproducing device according to Embodiment 2 of the present invention. Embodiment 2 is different from Embodiment 1 described above in that the genre setting unit 20 and the user input unit 21 have been removed and the internal structure of the highlight scene determination unit 500 has been changed. Therefore, a description will be given only to the differences by using the same reference numerals for the same portions as in Embodiment 1.

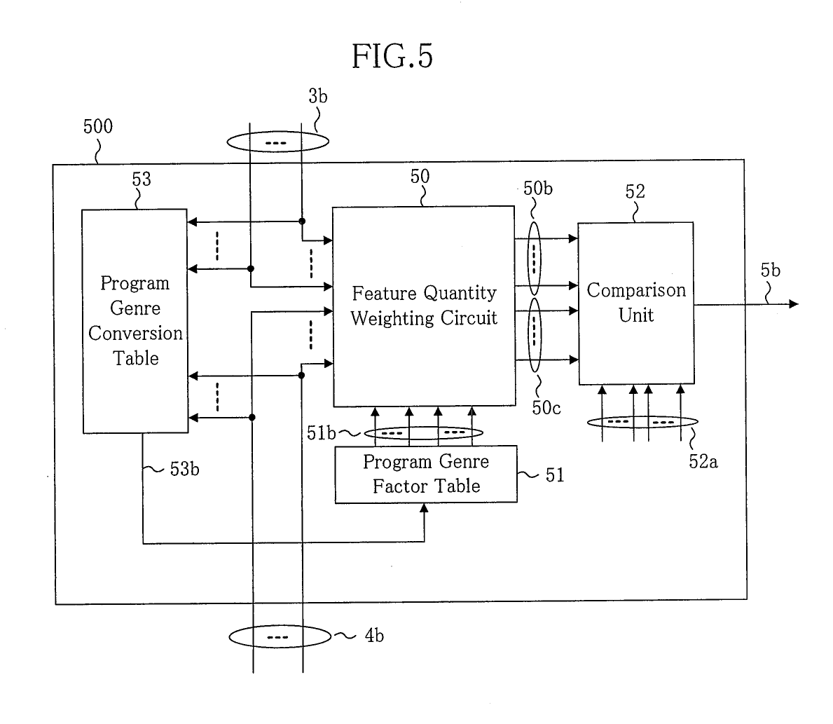

FIG. 5 is a block diagram showing a detailed structure of the highlight scene determination unit 500 in Embodiment 2. As shown in FIG. 5, the plurality of image feature quantity data 3b outputted from the image feature quantity extraction unit 3 and the plurality of sound feature quantity data 4b outputted from the sound feature quantity extraction unit 4 are inputted to the highlight scene determination unit 500 to be inputted to the feature quantity weighting circuit 50 and a program genre conversion table 53 in the highlight scene determination unit 500.

The program genre conversion table 53 mentioned above determines a program genre (e.g., news, movies, music programs, sports, or the like) to which the inputted image feature quantity data 3b and sound feature quantity data 4b are closer. The result of the determination is outputted as program genre conversion table information 53b to the program genre factor table 51.

Specifically, statistics of the respective distributions of the image feature quantity data 3b and the sound feature quantity data 4b are taken first in advance so that the results thereof are reflected on the program genre conversion table 53. The statistics of the distributions are referenced for comparison with the inputted image feature quantity data 3b and sound feature quantity data 4b so that the program genre (e.g., new, movies, music programs, sports, or the like) to which the currently inputted feature quantity data are closer is determined.

To the program genre factor table 51, the program genre conversion table information 53b outputted from the program genre conversion table 53 is inputted. From the program genre factor table 51, the feature quantity genre factors 51b in accordance with the respective feature quantity factors in the individual program genres, which are determined based on the program genre conversion table information 53b, are outputted to the feature quantity weighting circuit 50.

In the feature quantity weighting circuit 50 mentioned above, multiplications are performed respectively between the feature quantity genre factors 51b and the plurality of image feature quantity data 3b and between the feature quantity genre factors 51b and the plurality of sound feature quantity data 4b. From the feature quantity weighting circuit 50, the weighted image data 50b and the weighted sound data 50c as the results of the multiplications are outputted to the comparison unit 52.

Thus, the extracted image feature quantity data 3b and the extracted sound feature quantity data 4b are not reflected directly on the system, but there are peculiar parameters intensified on a per program-genre basis (the distribution of feature quantities greatly differs from one genre to another). As a result, by multiplying the image feature quantity data 3b and the sound feature quantity data 4b by the feature quantity genre factors 51b, it is possible to intensify the parameters which are peculiar to the individual genres, while weakening parameters which are not. This allows reliable scene determination.

The comparison unit 52 mentioned above compares the inputted weighted image data 50b and the inputted weight sound data 50c with the reference values 52a for the determination of a highlight scene. As a result of the comparison, when the reference values 52a are exceeded, the scene determination signal 5b indicating that the current input signal shows a highlight scene is outputted to the accumulation unit 7.

Thus, in the recording/reproducing device according to Embodiment 2, even in a system environment which does not have a program-related input interface, it becomes possible to automatically select the program genre.

### Embodiment 3

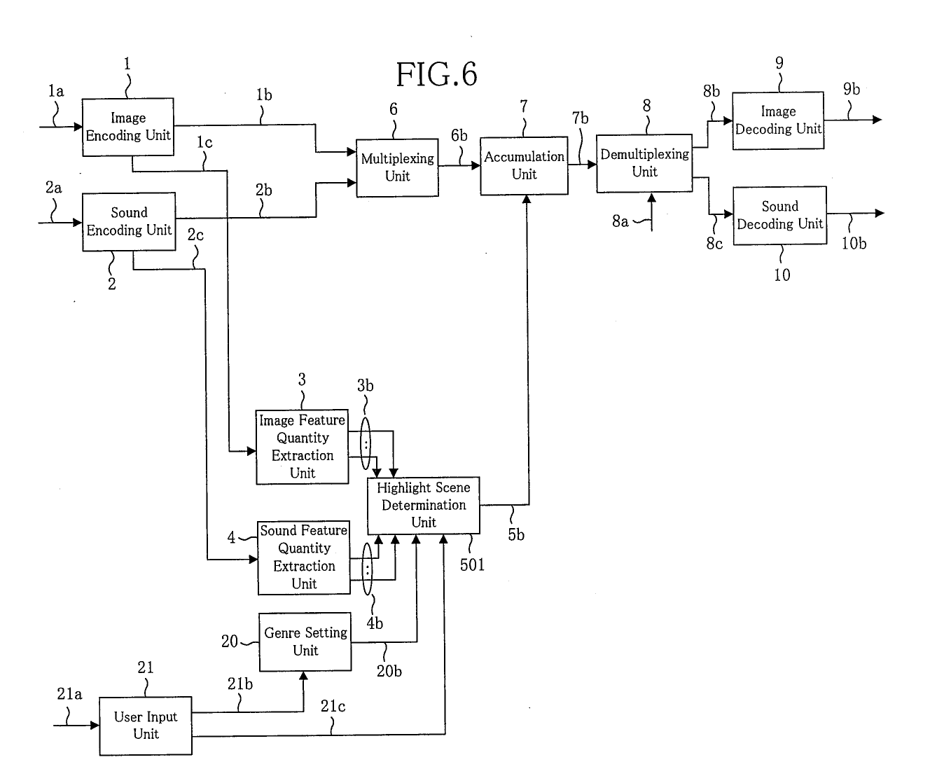

FIG. 6 is a block diagram showing a structure of a recording/reproducing device according to Embodiment 3 of the present invention. Embodiment 3 is different from Embodiment 1 described above in that previously recorded information 21c is further outputted from the user input unit 21. Therefore, a description will be given only to the differences by using the same reference numerals for the same portions as in Embodiment 1.

As shown in FIG. 6, the user input unit 21 receives the input 21a from the user and outputs the set program information 21b based on the input 21a to the genre setting unit 20, while outputting the previously registered information 21c to a highlight scene determination unit 501.

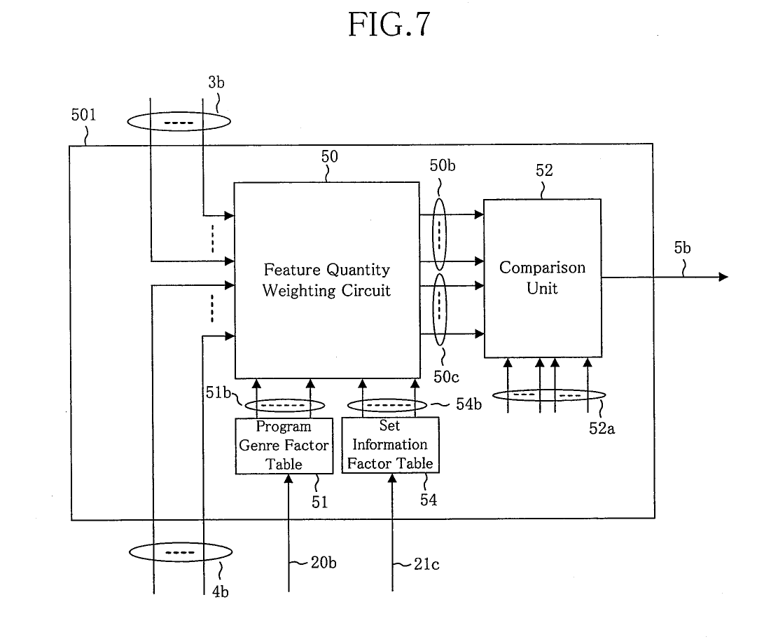

FIG. 7 is a block diagram showing a detailed structure of the highlight scene determination unit 501. The highlight scene determination unit 501 is different from the highlight scene determination unit 5 according to Embodiment 1 described above in that a set information factor table 54 has been added thereto and outputs of the set information factor table 54 are additionally newly inputted to the feature quantity weighting circuit 50.

As shown in FIG. 7, the program genre information 20b outputted from the genre setting unit 20 is inputted to the program genre factor table 51. From the program genre factor table 51, the feature quantity genre factors 51b in accordance with the respective feature quantity factors in the individual program genres, which are determined based on the program genre information 20b, are outputted to the feature quantity weighting circuit 50.

To the set information factor table 54, the detailed previously registered information 21c (e.g., when the program genre is sports, more detailed information such as baseball, soccer, judo, swimming, or the like) additionally set by the user and outputted from the user input unit 21 is inputted, and set information factors 54b determined based on the previously registered information 21c are outputted to the feature quantity weighting circuit 50.

The feature quantity weighting circuit 50 mentioned above performs respective multiplications between the plurality of image feature quantity data 3b and the feature quantity genre factors 51b and the set information factors 54b and between the plurality of sound feature quantity data 4b and the feature quantity genre factors 51b and the set information factors 54b. From the feature quantity weighting circuit 50, the weighted image data 50b and the weighted sound data 50c as the results of the multiplications are outputted to the comparison unit 52.

Thus, in the recording/reproducing apparatus according to Embodiment 3, the extracted image feature quantity data 3b and the extracted sound feature quantity data 4b are not reflected directly on the system, but there are peculiar parameters intensified on a per program-genre basis (i.e., the distribution of feature quantities greatly differs from one genre to another). As a result, by multiplying the image feature quantity data 3b and the sound feature quantity data 4b by the feature quantity genre factors 51b, it is possible to intensify the parameters which are peculiar to the individual genres, while weakening parameters which are not. This allows reliable scene determination.

Further, when the program genre is sports, it becomes possible to further intensify the peculiar parameters and perform more optimum scene determination by using more detailed information such as baseball, soccer, judo, swimming, or the like as the set information factors 54b and multiplying the image feature quantity data 3b and the sound feature quantity data 4b by the set information factors 54b.

### Embodiment 4

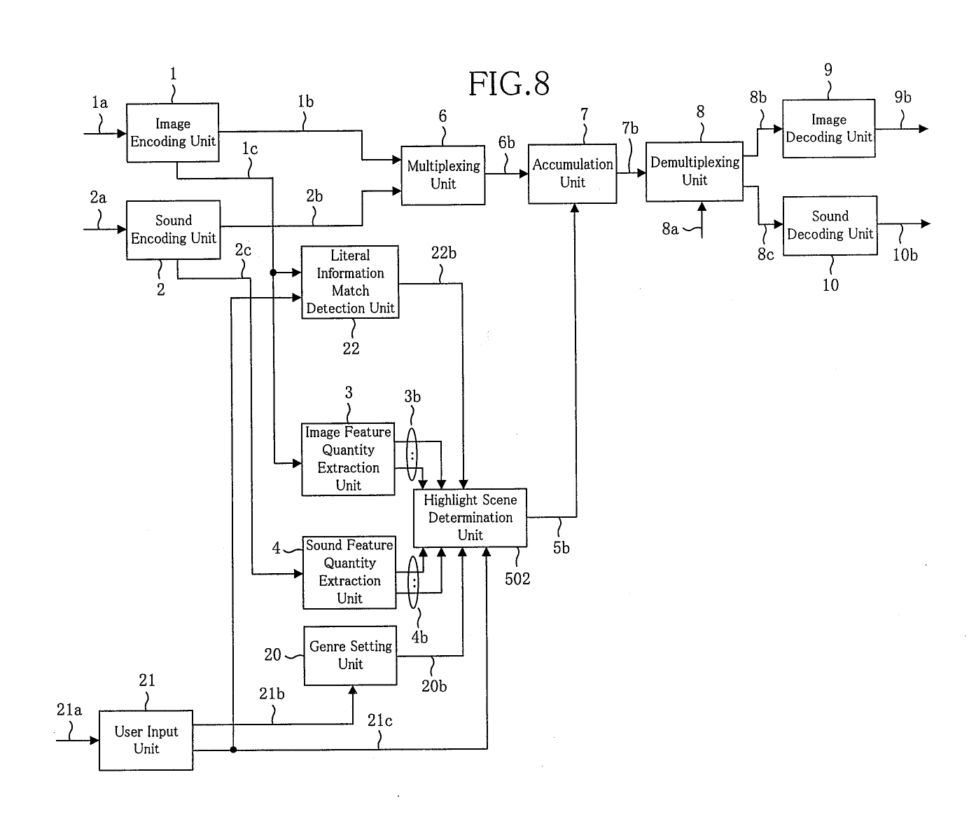

FIG. 8 is a block diagram showing a structure of a recording/reproducing device according to Embodiment 4 of the present invention. Embodiment 4 is different from Embodiment 3 described above in that a literal information match detection unit 22 has been provided. Therefore, a description will be given only to the differences by using the same reference numerals for the same portions as in Embodiment 3.

The image encoding unit 1 outputs the compressed image data 1b obtained by performing the encoding process with respect to the input image signal 1a to the multiplexing unit 6, while outputting the image-related data 1c including the frame information, luminance data, hue data, and movement vector information of the input image signal 1a to the image feature quantity extraction unit 3 and to the literal information match detection unit 22.

The user input unit 21 receives the input 21a from the user and outputs the set program information 21b based on the input 21a to the genre setting unit 20, while outputting the previously registered information 21c to a highlight determination unit 502 and to the literal information match detection unit 22.

The literal information match detection unit 22 mentioned above detects literal information from a telop during a program, subtitles in a movie program, or the like in the image-related data 1c outputted from the image encoding unit 1, while detecting a match between the detected literal information and literal information in the previously registered information 21c (the keyword of a related program or the like to be recorded) outputted from the user input unit 21. When a literal information match is detected, a literal match signal 22b is outputted to the highlight scene determination unit 502.

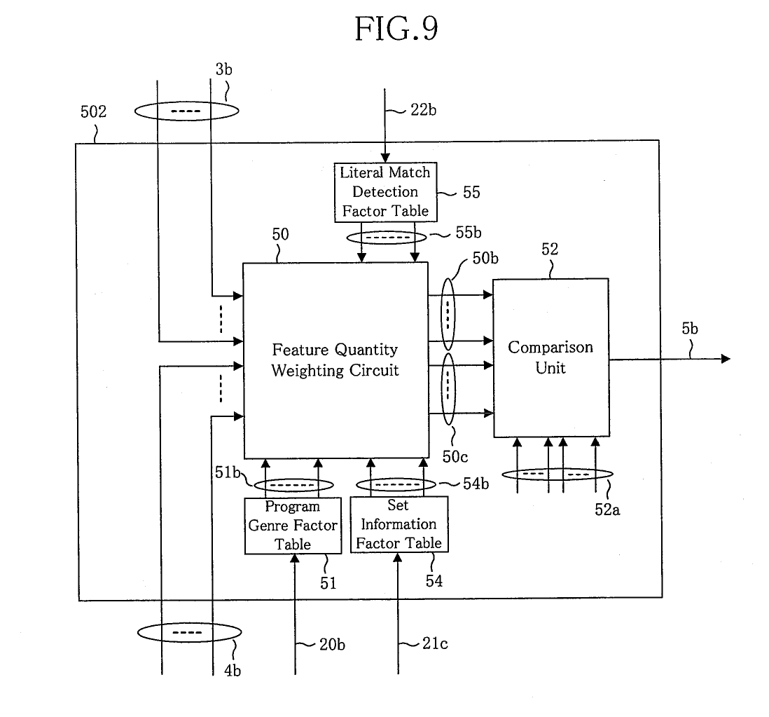

FIG. 9 is a block diagram showing a detailed structure of the highlight scene determination unit 502. The highlight scene determination unit 502 is different from the highlight scene determination unit 501 according to Embodiment 3 in that a literal match detection factor table 55 has been added thereto and literal match factors 55b as outputs of the literal match detection factor table 55 are additionally newly inputted to the feature quantity weighting circuit 50.

As shown in FIG. 9, the literal match signal 22b outputted from the literal information match detection unit 22 mentioned above is inputted to the literal match detection factor table 55. From the literal match detection factor table 55, the literal match factors 55b determined based on the literal match signal 22b are outputted to the feature quantity weighting circuit 50.

The feature quantity weighting circuit 50 mentioned above performs respective multiplications between the plurality of image feature quantity data 3b and the feature quantity genre factors 51b, the set information factors 54b, and the literal match factors 55b and between the plurality of sound feature quantity data 4b and the feature quantity genre factors 51b, the set information factors 54b, and the literal match factors 55b. From the feature quantity weighting circuit 50, the weighted image data 50b and the weighted sound data 50c as the results of the multiplications are outputted to the comparison unit 52.

Thus, in the recording/reproducing device according to Embodiment 4, the peculiar parameters can further be intensified based on the literal information such as a telop during a program or subtitles in a movie program. As a result, it becomes possible to reduce the frequency with which unneeded scenes the reproduction of which is not desired by the user are detected and implement more reliable scene determination for the user.

### Embodiment 5

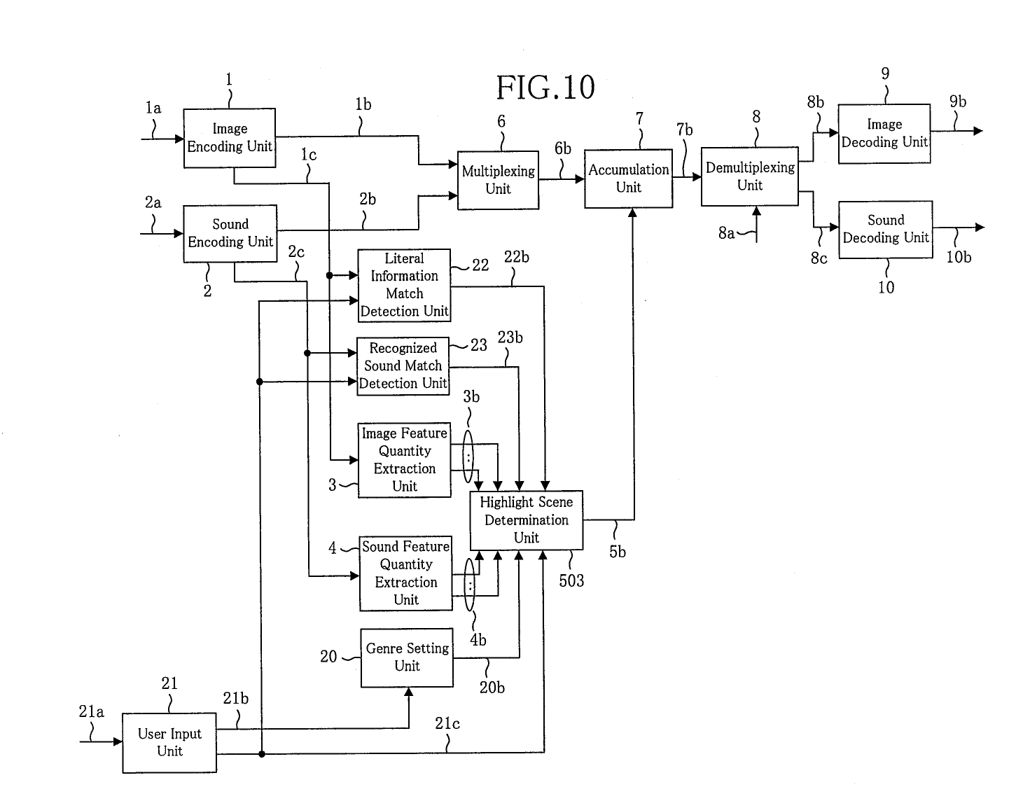

FIG. 10 is a block diagram showing a structure of a recording/reproducing device according to Embodiment 5 of the present invention. Embodiment 5 is different from Embodiment 4 described above in that a recognized sound match detection unit 23 is provided. Therefore, a description will be given only to the differences by using the same reference numerals for the same portions as in Embodiment 4.

The sound encoding unit 2 outputs the compressed sound data 2b obtained by performing the encoding process with respect to the input sound signal 2a to the multiplexing unit 6, while outputting the sound-related data 2c including the frame information, amplitude data, and spectrum information of the input sound signal 2a to the sound feature quantity extraction unit 4 and to the recognized sound match detection unit 23.

The user input unit 21 receives the input 21a from the user and outputs the set program information 21b based on the input 21a to the genre setting unit 20, while outputting the previously registered information 21c to a highlight scene determination unit 503, to the literal information match detection unit 22, and to the recognized sound match detection unit 23.

The recognized sound match detection unit 23 mentioned above recognizes sound information in the sound-related data 2c outputted from the sound encoding unit 2 to acquire a sound word, while detecting a match with the previously registered information 21c (the keyword of a related program or the like to be recorded) outputted from the user input unit 21. When the match with the sound word is detected, a word match signal 23b is outputted to the highlight scene determination unit 503.

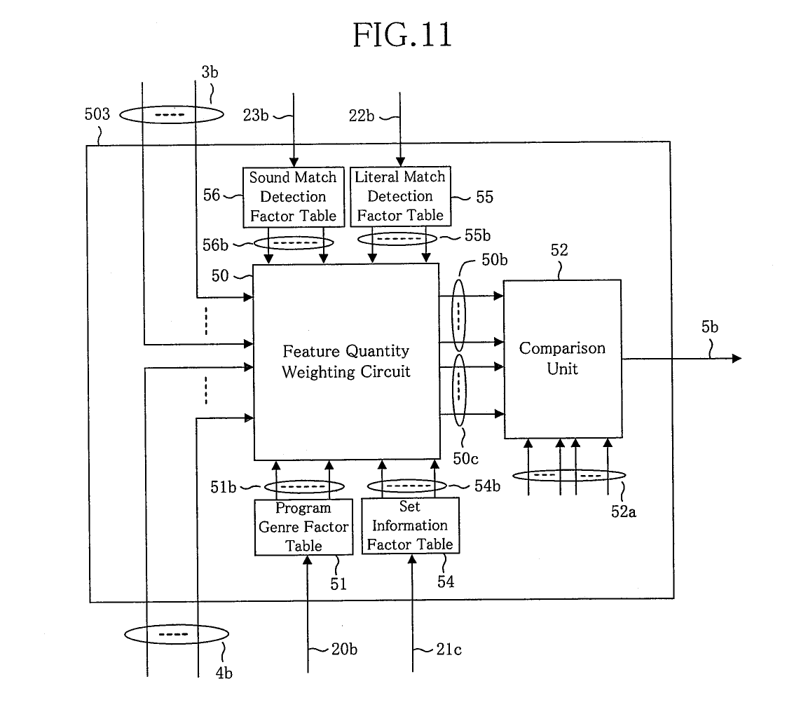

FIG. 11 is a block diagram showing a detailed structure of the highlight scene determination unit 503. The highlight scene determination unit 503 is different from the highlight scene determination unit 502 according to Embodiment 4 in that a sound match detection factor table 56 has been added thereto and sound match factors 56b as outputs of the sound match detection factor table 56 are additionally newly inputted to the feature quantity weighting circuit 50.

As shown in FIG. 11, the word match signal 23b outputted from the recognized sound match detection unit 23 mentioned above is inputted to the sound match detection factor table 56. From the sound match detection factor table 56, the sound match factors 56b determined based on the word match signal 23b are outputted to the feature quantity weighting circuit 50.

The feature quantity weighting circuit 50 mentioned above performs respective multiplications between the plurality of image feature quantity data 3b and the feature quantity genre factors 51b, the set information factors 54b, the literal match factors 55b, and the sound match factors 56b and between the plurality of sound feature quantity data 4b and the feature quantity genre factors 51b, the set information factors 54b, the literal match factors 55b, and the sound match factors 56b. From the feature quantity weighting circuit 50, the weighted image data 50b and the weighted sound data 50c as the results of the multiplications are outputted to the comparison unit 52.

Thus, in the recording/reproducing device according to Embodiment 5, the peculiar parameters can further be intensified based on the sound word in a program. As a result, it becomes possible to reduce the frequency with which unneeded scenes the reproduction of which is not desired by the user are detected and implement more reliable scene determination for the user.

### Embodiment 6

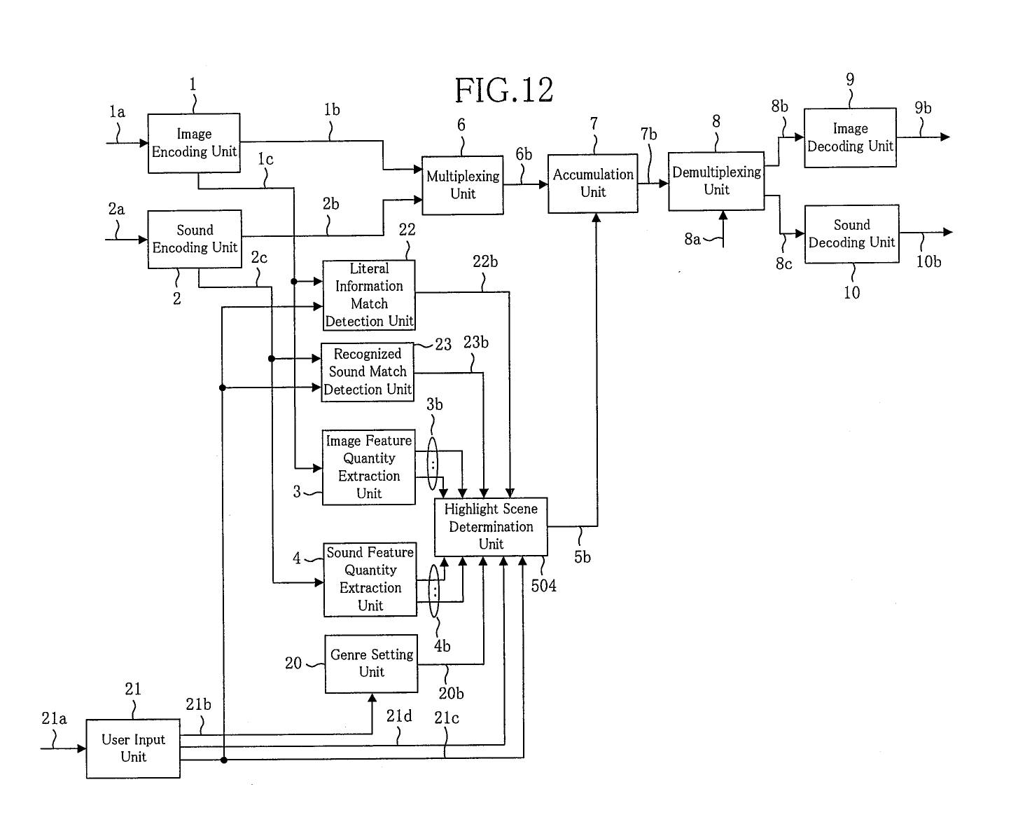

FIG. 12 is a block diagram showing a structure of a recording/reproducing device according to Embodiment 6 of the present invention. Embodiment 6 is different from Embodiment 5 described above in that satisfaction degree information 21d showing the degree of satisfaction of the user with respect to the result of reproduction of a highlight scene is further outputted from the user input unit 21. Therefore, a description will be given only to the differences by using the same reference numerals for the same portions as in Embodiment 5.

As shown in FIG. 12, the user input unit 21 receives the input 21a from the user and outputs the set program information 21b based on the input 21a to the genre setting unit 20, while outputting the previously registered information 21c and the satisfaction degree information 21d to a highlight scene determination unit 504.

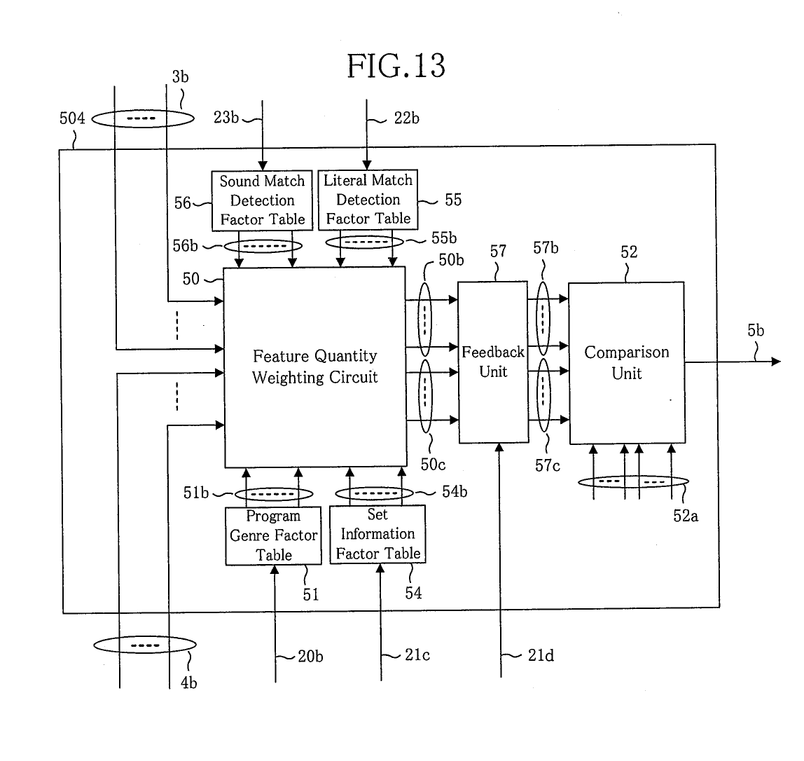

FIG. 13 is a block diagram showing a detailed structure of the highlight scene determination unit 504. The highlight scene determination unit 504 is different from the highlight scene determination unit 503 according to Embodiment 5 described above in that a feedback unit 57 is newly provided in a stage subsequent to the feature quantity weighting circuit 50.

As shown in FIG. 13, in the feature quantity weighting circuit 50 mentioned above, multiplications are performed between the plurality of image feature quantity data 3b and the feature quantity genre factors 51b, the set information factors 54b, the literal match factors 55b, and the sound match factors 56b and between the plurality of sound feature quantity data 4b and the feature quantity genre factors 51b, the set information factors 54b, the literal match factors 55b, and the sound match factors 56b. From the feature quantity weighting circuit 50, the weighted image data 50b and the weighted sound data 50c as the results of the multiplications are outputted to the feedback unit 57.

The feedback unit 57 mentioned above reflects the degree of satisfaction of the user with respect to the result of reproduction on the weighting of the feature quantity data in the highlight scene determination unit 504.

Specifically, the satisfaction degree information 21d outputted from the user input unit 21 is inputted to the feedback unit 57 mentioned above and, based on the satisfaction degree information 21d, the weighted image data 50b and the weighted sound data 50c as the results outputted from the feature quantity weighting circuit 50 are multiplied by factors in accordance with the degree of satisfaction. From the feedback unit 57, weighted image data 57b and weighted sound data 57c as the results of the multiplications are outputted to the comparison unit 52. The subsequent process is the same as in Embodiment 5.

As a result, the function of obtaining a feedback from the user is implemented by increasing the threshold value of the reference value 52a in the subsequent-stage comparison unit 52 to more accurately specify a highlight scene or by reducing the threshold value to detect a larger number of highlight scenes.

Although Embodiment 6 has multiplied the results outputted from the feature quantity weighting circuit 50 by the satisfaction degree factors, the present invention is not limited to the embodiment. For example, it is also possible to perform multiplications with respect to respective outputs of the individual factor tables which are the program genre factor table 51, the set information factor table 54, the literal match detection factor table 55, and the sound match detection factor table 56.

Thus, in the recording/reproducing device according to Embodiment 6, the highlight scene of a recorded program is reproduced and the degree of satisfaction of the user with respect to the result of the reproduction is inputted from the user input unit 21. As a result, it is possible to implement the feedback function which reflects the degree of satisfaction of the user on the weighting of the feature quantity data in the highlight scene determination unit 504 and enhance the degree of customer satisfaction.

### Embodiment 7

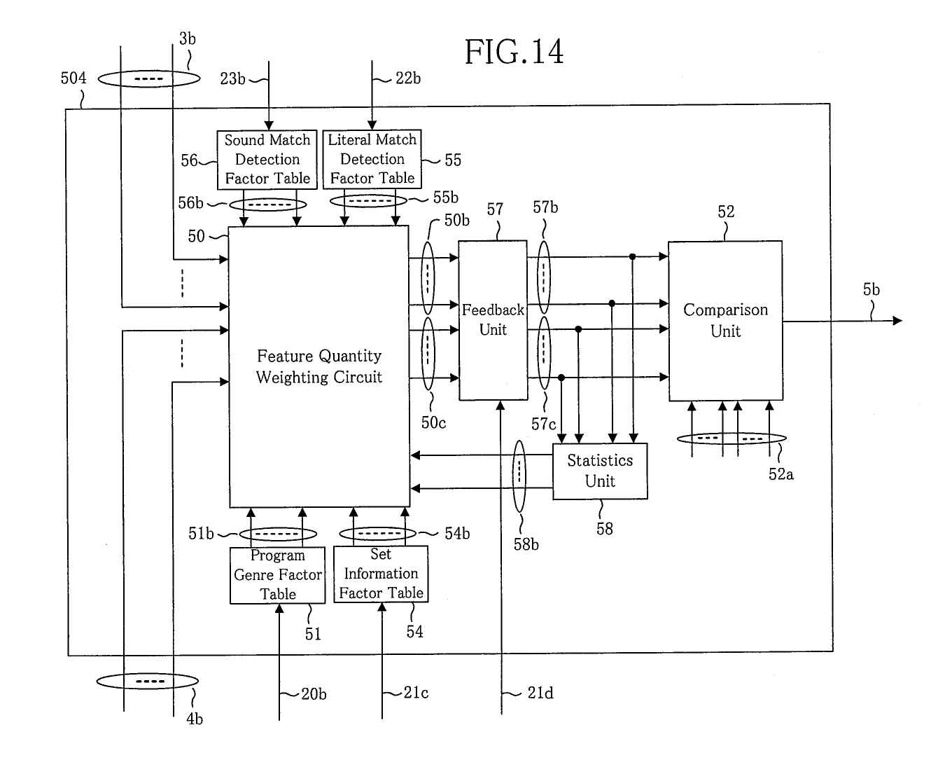

FIG. 14 is a block diagram showing a detailed structure of a highlight scene determination unit in a recording/reproducing device according to Embodiment 7. Embodiment 7 is different from Embodiment 6 described above in that a statistics unit 58 is newly provided. Therefore, a description will be given only to the differences by using the same reference numerals for the same portions as in Embodiment 6. As for the entire structure of the recording/reproducing device, it is the same as in Embodiment 6.

As shown in FIG. 14, in the feedback unit 57, the weighted image data 50b and the weighted sound data 50c as the results outputted from the feature quantity weighting circuit 50 are multiplied by the factors in accordance with the degree of satisfaction based on the satisfaction degree information 21d. From the feedback unit 57, the weighted image data 57b and the weighted sound data 57c as the results of the multiplications are outputted to each of the comparison unit 52 and the statistics unit 58.

The statistics unit 58 mentioned above summarizes and takes statistics of the respective distributions of the weighted image data 57b and the weighted sound data 57c as the result of weighting the results of detecting the respective feature quantities of an image and a sound based on an actual viewing history (programs, genres, broadcast channels, and the like) of the user. From the statistics unit 58, user statistics results 58b, which are the results of the statistics, are outputted and feedbacked to the feature quantity weighting circuit 50.

In the feature quantity weighting circuit 50 mentioned above, the image feature quantity data 3b and the sound feature quantity data 4b are weighted based on the user statistics results 58b mentioned above.

Thus, in the recording/reproducing device according to Embodiment 7, even when the system is under such a situation that there is no information set by the user, weighting with factors suited to the preference of the user can be automatically performed based on the viewing history of the user.

### Embodiment 8

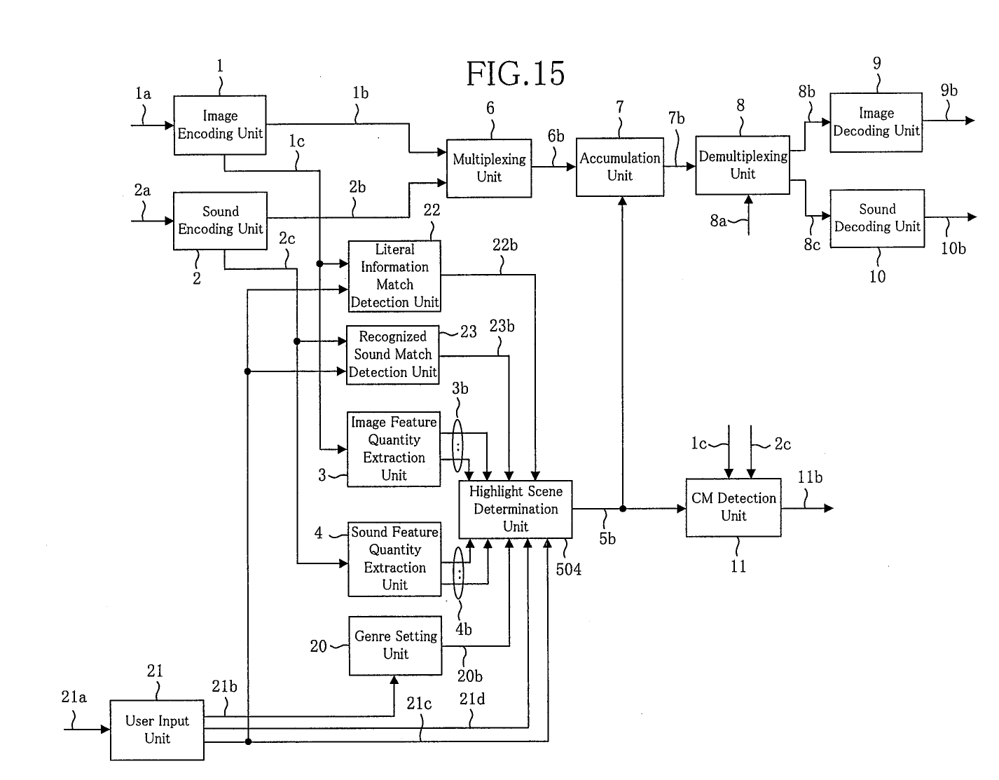

FIG. 15 is a block diagram showing a structure of a recording/reproducing device according to Embodiment 8. Embodiment 8 is different from Embodiment 7 described above in that a CM detection unit 11 is newly provided. Therefore, a description will be given only to the differences by using the same reference numerals for the same portions as in Embodiment 7.

As shown in FIG. 15, the image encoding unit 1 outputs the compressed image data 1b obtained by performing the encoding process with respect to the input image signal 1a to the multiplexing unit 6, while outputting the image-related data 1c including the frame information, luminance data, hue data, and movement vector information of the input image signal 1a to the image feature quantity extraction unit 3, to the literal information match detection unit 22, and to the CM detection unit 11.

The sound encoding unit 2 outputs the compressed sound data 2b obtained by performing the encoding process with respect to the input sound signal 2a to the multiplexing unit 6, while outputting the sound-related data 2c including the frame information, amplitude data, and spectrum information of the input sound signal 2a to the sound feature quantity extraction unit 4, to the recognized sound match detection unit 23, and to the CM detection unit 11.

The highlight scene unit 504 outputs the scene determination signal 5b indicating that the current input signal shows a highlight scene to the accumulation unit 7 and to the CM detection unit 11.

The CM detection unit 1 mentioned above detects a CM period in the inputted image-related data 1c and in the inputted sound-related data 2c based on the scene determination signal 5b.

Specifically, since it can be considered that characteristic situations (a scene change, a mute period, and the like) are present before and after a CM period in both image and sound reproduction, there are image and sound parameters which are peculiar to CM. Therefore, it becomes possible to utilize the scene determination signal 5b from the highlight scene determination unit 504 for CM detection.

Then, information showing the CM period detected in the CM detection unit 11 mentioned above is outputted as a CM detection result 11b.

Thus, in the recording/reproducing device according to Embodiment 8, the more stable CM detection result 11b can be obtained by reflecting the scene determination signal 5b on the determination parameters of a CM detecting function.

### INDUSTRIAL APPLICABILITY

As described above, the present invention achieves the highly practical effect of allowing effective and reliable reproduction of a scene desired by a user, and is therefore extremely useful and has a high industrial applicability. The present invention is particularly usable to such applications as a system, a device, a method for controlling recording and reproduction, and a control program each related to image/sound recording.

1. (canceled)

2. A recording/reproducing device comprising:
an image encoding unit for performing an encoding process with respect to an input image signal and outputting a compressed image data, while outputting an image-related data showing information related to an image in the input image signal;
a sound encoding unit for performing an encoding process with respect to an input sound signal and outputting a compressed sound data, while outputting a sound-related data showing information related to a sound in the input sound signal;
an image feature quantity extraction unit for receiving the image-related data, extracting respective quantities of features of the input image signal based on the image-related data, and outputting a plurality of image feature quantity data;
a sound feature quantity extraction unit for receiving the sound-related data, extracting respective quantities of features of the input sound signal based on the sound-related data, and outputting a plurality of sound feature quantity data;
a user input unit for receiving input information based on an operation by a user;
a genre setting unit for receiving set program information set in the user input unit and outputting program genre information showing a genre corresponding to the set program information;
a highlight scene determination unit for receiving the plurality of image feature quantity data and the plurality of sound feature quantity data, weighing both of the feature quantity data in accordance with the program genre information, comparing results of the weighing with reference values for determination of a highlight scene, and outputting a scene determination signal indicating the highlight scene based on results of the comparison;
a multiplexing unit for multiplexing the compressed image data and the compressed sound data in accordance with an encoding format and outputting a multiplexed stream data;
an accumulation unit for receiving the multiplexed stream data and the scene determination signal, writing both of the data in a recording medium, and reading the recorded multiplexed stream data only during a period in which the scene determination signal is valid when a highlight scene reproduction mode has been set or reading the recorded multiplexed stream data over an entire period when the highlight scene reproduction mode has not been set;
a demultiplexing unit for receiving the read stream, demultiplexing the read stream into a demultiplexed image stream and a demultiplexed sound stream, and outputting the demultiplexed image stream and the demultiplexed sound stream;
an image decoding unit for receiving the demultiplexed image stream, decompressing the compressed image data, and outputting the decompressed image data as a demodulated image signal; and
a sound decoding unit for receiving the demultiplexed sound stream, decompressing the compressed sound data, and outputting the decompressed sound data as a demodulated sound signal, wherein
the highlight scene determination unit is constructed to compare the plurality of image feature quantity data and the plurality of sound feature quantity data with results of taking statistics of respective distributions of individual feature quantities of the image and the sound on a per program-genre basis and weight the plurality of image feature quantity data and the plurality of sound feature quantity data based on results of the comparison.

3. (canceled)

4. (canceled)

5. (canceled)

6. (canceled)

7. A recording/reproducing device comprising:
an image encoding unit for performing an encoding process with respect to an input image signal and outputting a compressed image data, while outputting an image-related data showing information related to an image in the input image signal;
a sound encoding unit for performing an encoding process with respect to an input sound signal and outputting a compressed sound data, while outputting a sound-related data showing information related to a sound in the input sound signal;
an image feature quantity extraction unit for receiving the image-related data, extracting respective quantities of features of the input image signal based on the image-related data, and outputting a plurality of image feature quantity data;
a sound feature quantity extraction unit for receiving the sound-related data, extracting respective quantities of features of the input sound signal based on the sound-related data, and outputting a plurality of sound feature quantity data;
a user input unit for receiving input information based on an operation by a user;
a genre setting unit for receiving set program information set in the user input unit and outputting program genre information showing a genre corresponding to the set program information;
a highlight scene determination unit for receiving the plurality of image feature quantity data and the plurality of sound feature quantity data, weighing both of the feature quantity data in accordance with the program genre information, comparing results of the weighing with reference values for determination of a highlight scene, and outputting a scene determination signal indicating the highlight scene based on results of the comparison;
a multiplexing unit for multiplexing the compressed image data and the compressed sound data in accordance with an encoding format and outputting a multiplexed stream data;
an accumulation unit for receiving the multiplexed stream data and the scene determination signal, writing both of the data in a recording medium, and reading the recorded multiplexed stream data only during a period in which the scene determination signal is valid when a highlight scene reproduction mode has been set or reading the recorded multiplexed stream data over an entire period when the highlight scene reproduction mode has not been set;
a demultiplexing unit for receiving the read stream, demultiplexing the read stream into a demultiplexed image stream and a demultiplexed sound stream, and outputting the demultiplexed image stream and the demultiplexed sound stream;
an image decoding unit for receiving the demultiplexed image stream, decompressing the compressed image data, and outputting the decompressed image data as a demodulated image signal;
a sound decoding unit for receiving the demultiplexed sound stream, decompressing the compressed sound data, and outputting the decompressed sound data as a demodulated sound signal;
a literal information match detection unit for detecting literal information in an image in the image-related data, while detecting a match between the detected literal information and literal information in the previously registered information set in the user input unit and outputting a literal match signal; and
a sound information match detection unit for recognizing a word in a sound in the sound-related data, while detecting a match between the recognized sound word and the literal information in the previously registered information set in the user input unit and outputting a word match signal, wherein
the highlight scene determination unit is constructed to
receive previously registered information corresponding to a program genre set in the user input unit and weight the plurality of image feature quantity data and the plurality of sound feature quantity data based on the previously registered information,
weight the plurality of image feature quantity data and the plurality of sound feature quantity data based on the literal match information,
weight the plurality of image feature quantity data and the plurality of sound feature quantity data based on the word match information,
weight the plurality of image feature quantity data and the plurality of sound feature quantity data based on satisfaction degree information showing a degree of satisfaction of the user with respect to a result of reproduction of the highlight scene set in the user input unit, and
summarize and take statistics of respective distributions of the individual feature quantities in the plurality of image feature quantity data and the plurality of sound feature quantity data and weight the plurality of image feature quantity data and the plurality of sound feature quantity data based on results of the statistics.

8. (canceled)
